(19) United States
(12) Patent Application Publication
(10) Pub. No.: US 2007/0069902 A1
(43) Pub. Date: Mar. 29, 2007

(54) Child safety alert system for a motor vehicle

(76) Inventor: Joe L. Garrett, Baytown, TX (US)

Correspondence Address: JAMES RAY & ASSOCIATES, 2640 PITCAIRN ROAD, MONROEVILLE, PA, 15146, US

(21) Appl. No.: 11/527,368

(22) Filed: Sep. 26, 2006

Related U.S. Application Data
(60) Provisional application No. 60/720,700, filed on Sep. 27, 2005.

(51) Int. Cl. G08B 23/00

(52) U.S. Cl. 340/573.1

(57) ABSTRACT

A child safety alert system for a motor vehicle includes a combination of a first magnet which is attached to a driver door of such motor vehicle and a second magnet which is attached to a predetermined portion of such motor vehicle for detecting a condition wherein a door is opened and for providing a signal characterizing such door open condition. A device which is coupled to the second magnet is responsive to the door open signal for generating and broadcasting an alert to a driver of such motor vehicle to inspect for presence of a child or children in close proximity to such motor vehicle.

### CROSS-REFERENCE TO RELATED APPLICATIONS

This application is related to and claims priority from U.S. Provisional Patent Application Ser. No. 60/720,700 filed on Sep. 26, 2006.

### FIELD OF THE INVENTION

The present invention relates, in general, to child safety and, more particularly, this invention relates to a child safety alert system for a motor vehicle and, yet more particularly, the instant invention relates to child safety alert system for alerting the driver of the motor vehicle to inspect for presence of a child prior to starting the motor vehicle.

### BACKGROUND OF THE INVENTION

As is generally well known, children have a tendency to play without being aware of their surroundings including motor vehicles stationed in a close proximity to the playing area. It has been found that busy or preoccupied adults may overlook a small child or children who may be playing in the close proximity to such motor vehicle. Therefore, when the driver enters and starts the vehicle, the driver begins to move prior to observing the child or children behind, besides and underneath the vehicle. This can lead to accidents of varied severity. Child or children may be bumped, hit or completely run over by the vehicle if the driver fails or is unable to see them when leaving the driveway or parking space. Furthermore, drivers of the larger vehicles such as vans, pick-up truck and sport utility vehicles may not have the ability to see clearly on any side or beneath the vehicle due to its size.

Therefore, there is a need for a child safety system to alert the driver of a motor vehicle to inspect for presence of a child or children prior to starting such motor vehicle.

### SUMMARY OF THE INVENTION

According to one embodiment, the present invention provides a child safety alert system for a motor vehicle. The system includes a sensor means which is capable of detecting a condition wherein a door is opened and for providing a signal characterizing the door open condition. A device which is responsive to the provided door open signal alerts a driver of such motor vehicle to inspect for presence of a child or children in close proximity to such motor vehicle.

According to another embodiment of the invention, there is provided a method of alerting a driver of a motor vehicle to inspect for presence of a child who may be located in a position being at least one of behind, besides and beneath the motor vehicle. The method includes the step of sensing a condition wherein a door of the motor vehicle is opened. Then, generating a predetermined alert in response to the sensed door opened condition. Finally, broadcasting the predetermined alert to the driver to inspect for presence of the child prior to starting the motor vehicle.

### OBJECTS OF THE INVENTION

It is, therefore, one of the primary objects of the present invention to provide a child safety alert system for a motor vehicle.

Another object of the present invention is to provide a child safety alert system for a motor vehicle which is activated when a door of the motor vehicle is opened prior to starting such motor vehicle.

Yet another object of the present invention is to provide a child safety alert system for a motor vehicle which broadcasts a voice message to the driver to inspect for presence of a child or children when the driver opens the door of such motor vehicle.

A further object of the present invention is to provide a child safety alert system for a motor vehicle which is easily installed on existing motor vehicles.

Yet a further object of the present invention is to provide a child safety alert system for a motor vehicle which is simple to use.

An additional object of the present invention is to provide a child safety alert system for a motor vehicle which is economical to manufacture.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is an elevation view of a child safety alert system constructed according to a presently preferred embodiment of the invention for a motor vehicle, which is partially illustrated;

FIG. 2 is a front planar view of an alert generating device employed in the child safety alert system of FIG. 1;

FIG. 3 is a rear planar view of the device of FIG. 2; and

FIG. 4 is a block diagram of the child safety alert system of FIG. 1.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

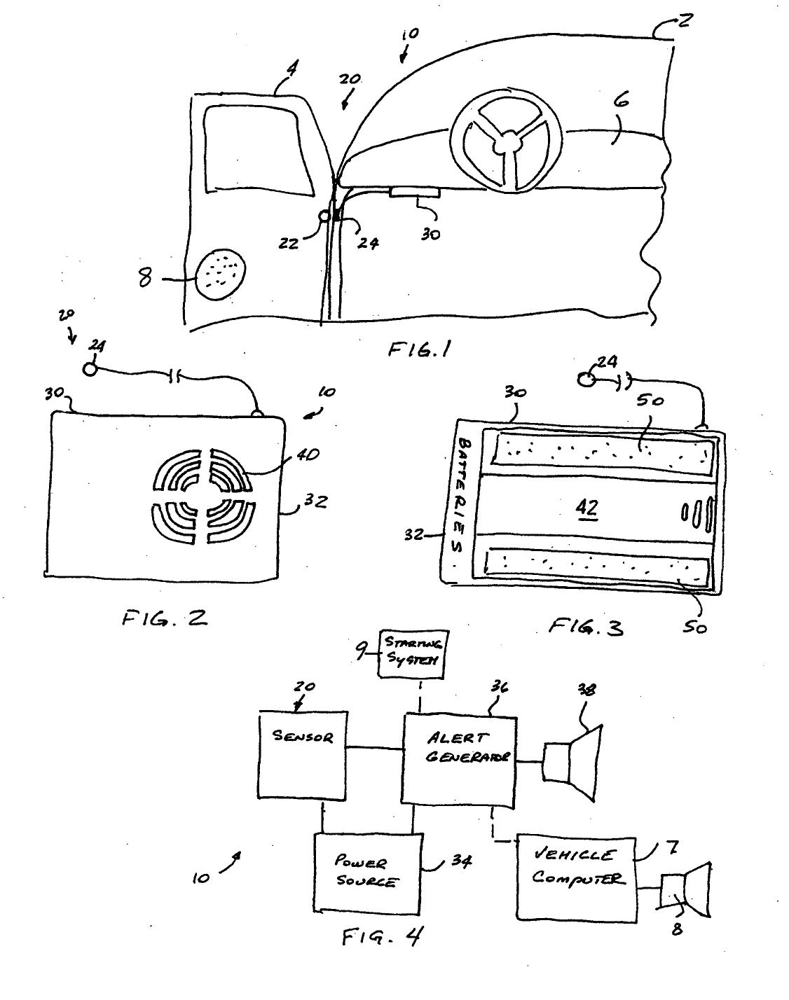

Reference is now made, to FIGS. 1-4, wherein there is shown a child safety alert system, generally designated 10, for a motor vehicle 2. The system 10 includes a sensor means, generally designated as 20, which is capable of detecting a condition wherein a door 4 of such motor vehicle 2 is opened. Preferably, the door 4 is a driver door 4 as best shown in FIG. 1. When the sensor means 20 detects the door open condition, it provides a signal characterizing such door open condition. A device 30 is responsive to the door open signal for alerting a driver of such motor vehicle 2 to inspect for presence of a child or children potentially being located in a close proximity to such motor vehicle 2.

In the presently preferred embodiment of the invention, the sensor means 20 includes a first magnet 22 which is attached to such door 4 and a second magnet 24 which is coupled to the device 30 and which is mounted in a close proximity to the first magnet 22 when such door 4 is closed. In operation, when the door 4 is opened, the loss of the magnetic field between the first magnet 22 and the second magnet 24 generates the door open signal.

The device 30 includes a housing 32, a source of power supply 34, preferably being at least one battery 34, and an alert generation means 36 which is coupled to the power supply source 34 and to the second magnet 24 for generating a predetermined alert upon receiving the door open signal.

According to one embodiment of the invention, the alert generation means 36 is a simple audible alarm 36 and such predetermined alert is a sound of a predetermined frequency. According to another embodiment of the invention, the alert generation means 36 includes a speaker means 38 which is positioned behind a speaker port 40 provided in the front surface of the housing 32 for broadcasting at least one voice message. By way of example, such at least one voice message which is broadcasted as “Please check behind, besides and beneath the vehicle for children” will be sufficient to alert the driver.

The device 30 is mounted within a predetermined portion of such motor vehicle 2, preferably such as a passenger compartment. It is further preferred that the system 10 includes means, such as a pair of adhesive strips 50, which are best shown in FIG. 3 and which are attached to the a surface of the housing 32 for mounting the device 30 to a dashboard 6 of such motor vehicle 2.

By way of example in FIG. 3, the rear surface of the housing 32 is at least partially formed as a removable cover 42 for removing and inserting at least one battery 34. It will be understood though that the device 30 may be adapted to remove and insert the at least one battery 34 from the front surface or any edge portion of the housing 32.

It would be apparent to those skilled in the art that when the driver opens the door 4, the door open signal is generated due to loss of the magnetic field between the first magnet 22 and the second magnet 24 and such door open signal triggers the alert generation means 36 causing it to generate and broadcast at least one voice message which alerts the driver to inspect for presence of the child behind, besides and underneath the vehicle 2.

The alert generation means 36 may be connected to the vehicle computer 7 or to the starting system 9 to sense a second condition wherein the starting system 9 is deactivated. This would cause generation of the predetermined alert generally prior to starting such motor vehicle 2. It will be appreciated that the alert generation means 36 will be adapted with a required control circuit means.

After the driver completed the inspection and closes the door 4, the magnetic field is restored causing termination of the door open signal and deactivation of the alert generation means 36.

It will be appreciated that the system 10 of the present invention can be easily installed into the existing vehicle 2 as an after market accessory. Conveniently, the device 30 is mounted under the dashboard 6 and the second magnet 24 is mounted onto a frame portion of the motor vehicle 2 for ease of installation and for aesthetic purposes.

Although the present invention has been shown in terms of using at least one battery 34 to power alert generation means 36 and the second magnet 24, it will be apparent to those skilled in the art, that the sensor means 20 and the device 30 of the present invention may be connected directly to the battery (not shown) of the motor vehicle 2.

Furthermore, the first magnet 22 may be replaced by a target mounted on the door 4 and the second magnet 24 may be replaced by a sensor means, such as a proximity sensor, which is positioned to sense presence of the target and to provide the door open signal when it cannot sense the target.

Additionally, the at least one voice message which alerts the driver to inspect for presence of the child behind, besides and underneath the motor vehicle 2 may be generated by the vehicle computer 7 when it detects a condition wherein the driver door 4 has been opened and furthermore, when the starting system 9 of such vehicle 2 is activated. Furthermore, the at least one voice message may be broadcasted by the at least one speaker 8 which is illustrated for the sake of example in FIG. 1 as being mounted within the door 4.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A child safety alert system for a motor vehicle, said system comprising:
(a) a sensor means capable of detecting a condition wherein a door is opened and for providing a signal characterizing said door open condition; and
(b) a device which is responsive to said provided door open signal for alerting a driver of such motor vehicle to inspect for presence of a child or children in close proximity to such motor vehicle.

2. The system, according to claim 1, wherein said sensor means includes a first magnet which is attached to such door and a second magnet which is coupled to said device and which is attached to a predetermined portion of such motor vehicle and in a close proximity to said first magnet when such door is closed.

3. The system, according to claim 1, wherein said device includes a housing and an alert generation means which is coupled to a power supply source and to said sensor means for generating a predetermined alert upon receiving said door open signal.

4. The system, according to claim 3, wherein said system includes said power supply source which is mounted within said housing.

5. The system, according to claim 4, wherein said power supply source is at least one battery.

6. The system, according to claim 3, wherein said alert generation means is an audible alarm.

7. The system, according to claim 3, wherein said alert generation means includes a speaker means which is positioned behind a speaker port formed in said housing for broadcasting at least one voice message.

8. The system, according to claim 1, wherein said device is mounted within a passenger compartment of such motor vehicle.

9. The system, according to claim 8, wherein said system includes means for mounting said device to a predetermined portion of such motor vehicle.

10. The system, according to claim 9, wherein said mounting means includes a pair of adhesive members for mounting said device to a rigid portion of such motor vehicle.

11. The system, according to claim 3, wherein said alert generation means is coupled to a vehicle computer for sensing a second condition wherein a starting system of such motor vehicle is deactivated and wherein said predetermined alert is generated when said second condition is sensed.

12. A method of alerting a driver of a motor vehicle to inspect for presence of a child who may be located in a position being at least one of behind, besides and beneath said motor vehicle, said method comprising the steps of:
(a) sensing a condition wherein a door of said motor vehicle is opened;
(b) generating a predetermined alert in response to said door opened condition sensed in step (a); and
(c) broadcasting said predetermined alert to said driver to inspect for presence of said child prior to starting said motor vehicle.

13. The method, according to claim 12, wherein said method includes the step of sensing a second condition wherein a starting system of said motor vehicle is deactivated.

14. The method, according to claim 12, wherein said predetermined alert is generated in step (b) by a computer system of said motor vehicle.

15. The method, according to claim 14, wherein said predetermined alert is broadcasted in step (c) by at least one speaker disposed within said motor vehicle.

16. The method, according to claim 12, wherein said door opened condition is sensed in step (a) by a sensor means having a first member attached to said door and having a second member attached to a predetermined portion of said motor vehicle and in a close proximity to said first member when said door is closed, said sensor means capable of providing a signal characterizing said door open condition.

17. The method, according to claim 16, wherein said predetermined alert is generated in step (b) by a device which is attached to a second predetermined portion of said motor vehicle and is coupled to said second member for receiving said door open signal and wherein said predetermined alert is generated in response to a receipt of said door open signal.

18. The method, according to claim 17, wherein said device further includes a speaker means disposed therein for broadcasting said predetermined alert.
